(19) United States
(12) Patent Application Publication
(10) Pub. No.: US 2013/0250801 A1
(43) Pub. Date: Sep. 26, 2013

(54) METHOD AND APPARATUS FOR AUTO-REGISTERING DEVICES IN A WIRELESS NETWORK

(71) Applicants: SEAN PATRICK KENNEDY, San Diego, CA (US); Gary Robert Lyons, San Diego, CA (US); Edward Theodore Winter, San Diego, CA (US)

(72) Inventors: SEAN PATRICK KENNEDY, San Diego, CA (US); Gary Robert Lyons, San Diego, CA (US); Edward Theodore Winter, San Diego, CA (US)

(73) Assignee: Sony Corporation, Tokyo (JP)

(21) Appl. No.: 13/425,243

(22) Filed: Mar. 20, 2012

(51) Int. Cl. H04L 12/28

(52) U.S. Cl. 370/254

(57) ABSTRACT

A method for auto-registering a device in a network comprising detecting a coupling of the device to a router, retrieving network configuration data for the router and transmitting the network configuration through the coupling.

### BACKGROUND

1. Field of the Invention

Embodiments of the present invention generally relate to network configuration of wireless devices and, more particularly, to a method and apparatus for auto-registering devices in a wireless network.

2. Description of the Related Art

In the modern home, there are often multiple individuals accessing the internet simultaneously. Often each individual may access the internet through several devices such as a notebook computer, a smart-phone, a desktop computer and a tablet computer depicted as devices 101_{1 . . . 3} in FIG. 1. In one home, there may be several notebook computers, desktop computers, tablets and smart-phones accessing the internet simultaneously. Subscribing to a different internet service provider (ISP) for each device is costly and unmanageable, thus a local area network 100 is configured so that each of these devices 101_{1 . . . 3} can share one internet connection via one ISP.

With multiple devices in the home, configuring each device to connect to the internet becomes increasingly tedious. As discussed above, a user must configure each device 101_{1 . . . 3} to couple either wirelessly or with a wired data cable to a router 102 acting as an interface to the internet 104. Additionally, if the router is a wireless router and has security features enabled, the user must view a long character string representing a security key preconfigured on the router, copy the key down manually, and type the key in the connecting device to be able to use the internet. Performing this configuration process multiple times is tedious and error-prone and results in user frustration.

Therefore, there exists a need to provide a method and apparatus for auto-registering devices in a network thereby reducing configuration time and user frustration.

### SUMMARY OF THE INVENTION

Embodiments of the present disclosure generally include a method for auto-registering a device in a network comprising detecting a coupling of the device to a router, retrieving network configuration data for the router and transmitting the network configuration data through the coupling.

Embodiments of the present disclosure generally include an apparatus for auto-registering a device in a network comprising a detection module for detecting a coupling of the device to a router, retrieving network configuration data for the router and transmitting the network configuration data to the device through the coupling.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an illustration of a local area network according to the reference art;

FIG. 2 depicts a functional block diagram of a computer system interfacing with a network router in a home network in accordance with exemplary embodiments of the present invention;

FIG. 3 depicts a flow diagram of a method for detecting auto-configuring network devices in accordance with an embodiment of the present invention;

FIG. 4 depicts a flow diagram of a method 400 for auto-configuring a networked computer to a local area network in accordance with an embodiment of the present invention;

FIG. 5 depicts a block diagram of a mixed configuration local area network in accordance with embodiments of the present invention;

FIG. 6 depicts a flow diagram of a method for auto-configuring local area network enabled devices to a network in accordance with embodiments of the present invention;

FIG. 7 depicts a flow diagram of a method for auto-configuring non-local area network devices to a network in accordance with embodiments of the present invention; and

FIG. 8 depicts a flow diagram of a method for auto-configuring multiple devices to a public network and enabling quarantining in accordance with embodiments of the present invention.

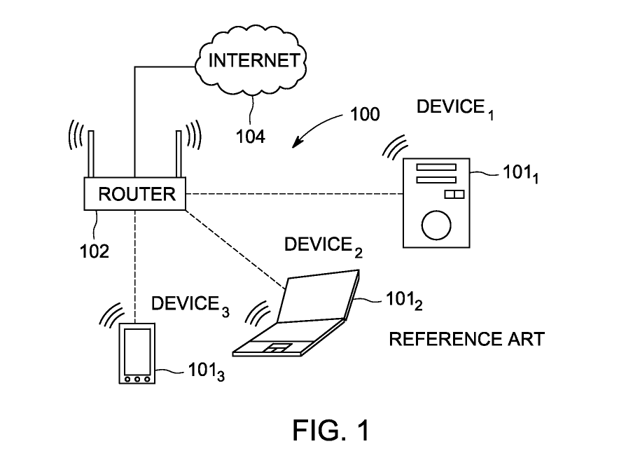

### DETAILED DESCRIPTION

As explained further below, various embodiments of the invention disclose a method and apparatus for auto-registering wireless devices in a network. In one embodiment, a user physically couples an internet enabled device to a router installed in a home network. The router detects the coupling and transmits a signal to the device to launch auto-registration software and also transmits network configuration data of the router to the device. The device automatically launches the auto-registration software client to configure network settings based on the router's network configuration data. Once the network settings are completed, the device is physically uncoupled from the network and retains networking functionality through a wireless coupling. In this manner, wireless device auto-registration (WDAR) is enabled through the WDAR router.

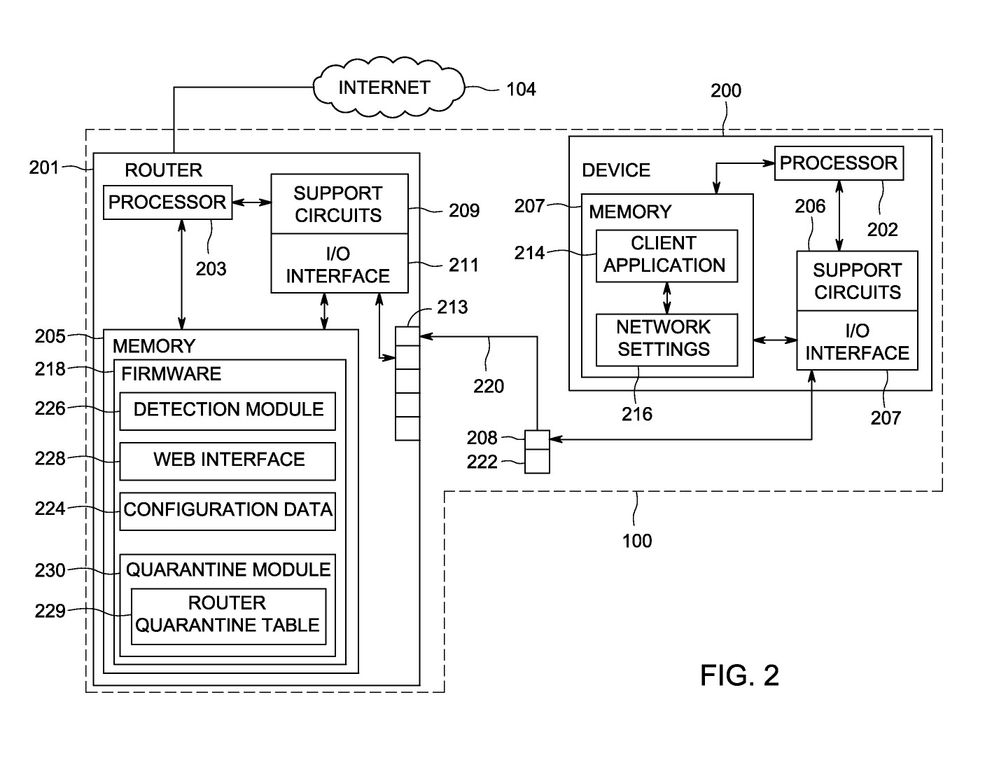

FIG. 2 depicts a functional block diagram of a computer system 200 interfacing with a network router 201 in a home network 100 in accordance with exemplary embodiments of the present invention. The computer system 200 includes a processor 202, a memory 204 and various supporting circuits 206. The processor 202 may include one or more microprocessors known in the art, and/or dedicated function processors such as field programmable gate arrays programmed to perform dedicated processing functions. The supporting circuits 206 for the processor 202 include microcontrollers, application specific integrated circuits (ASIC), cache, power supplies, clock circuits, data registers, an I/O interface 207, and the like.

The I/O interface 207 may be directly coupled to the memory 204 or coupled through the supporting circuits 206. The I/O interface 207 may also be configured for communication with input devices and/or output devices 208 and 222, such as, network devices, various storage devices, mouse, keyboard, displays, sensors and the like. In an exemplary embodiment, the device 208 comprises an Ethernet port for data transfer and a wireless transmitter/receiver 222, which accepts WiFi™ connections from wireless access points and routers.

The memory 204 stores non-transient processor-executable instructions and/or data that may be executed by and/or used by the processor 202. These processor-executable instructions may comprise firmware, software, and the like, or some combination thereof. Modules having processor-executable instructions that are stored in the memory 204 comprise a client application module 214. Further, the memory 204 stores network settings 216, such as the internet protocol (I.P.) address for the computer system 200, domain name server (DNS) IP addresses, gateway server IP address and protocol type. In an exemplary embodiment, the memory 204 may include one or more of the following: random access memory, read only memory, magneto-resistive read/write memory, optical read/write memory, cache memory, magnetic read/write memory, and the like, as well as signal-bearing media, excluding non-transitory signals such as carrier waves and the like.

The router 201 includes a processor 203, a memory 205 and various supporting circuits 209. The processor 202 may include one or more microprocessors known in the art, and/or dedicated function processors such as field programmable gate arrays programmed to perform dedicated processing functions. The supporting circuits 209 for the processor 203 include microcontrollers, application specific integrated circuits (ASIC), cache, power supplies, clock circuits, data registers, I/O interface 211, and the like. The I/O interface 211 may be directly coupled to the memory 204 or coupled through the supporting circuits 209. The I/O interface 211 may also be configured for communication with input devices and/or output devices 213, such as network devices and the like. In an exemplary embodiment, the device 211 comprises an array of Ethernet ports for downstream data transfer to client devices and one upstream connection to the Internet 104.

The memory 205 stores non-transient processor-executable instructions and/or data that may be executed by and/or used by the processor 202. These processor-executable instructions may comprise firmware 218, software, and the like, or some combination thereof. In an exemplary embodiment, the memory 205 may include one or more of the following: random access memory, read only memory, magneto-resistive read/write memory, optical read/write memory, cache memory, magnetic read/write memory, and the like, as well as signal-bearing media, excluding non-transitory signals such as carrier waves and the like.

Computer system 200, in an exemplary embodiment, is a general purpose computing device such as a notebook computer, a desktop computer, a smart-phone, tablet or the like. The system 200 is initially coupled to the router 201 through a data cable 220 through the respective I/O ports 208 and 213, but a user may wish to use the WiFi port 222 to connect to the internet 104 through router 201. When the computer system 200 makes a request to access a site on the internet, all requests are routed through the router 201. However, before computer system 200 is configured to use router 201 through WiFi port 222, the system 200 must have all the required connection data such as an I.P. address, the DNS server addresses assigned by the ISP, and a security key, all stored as network configuration data 224 in the memory 205 of router 201. In differing embodiments, the connection may be initiated by the router 201 or a client device such as system 200 in a public wireless setting.

To automatically configure the computer system 200 with the wireless configuration of the router 201, the network configuration data must be transmitted to the computer system 200. The data cable 220 couples the computer system 200 and the router 201. According to exemplary embodiments, the data cable 220 is an Ethernet cable, a universal serial bus (USB) cable or the like. The firmware 218 comprises a web interface 228, a detection module 226, and a quarantine module 230. The quarantine module 230 further contains a router quarantine table 229. The web interface 228 is used by a user to configure network settings such as wireless security type, dynamic or static routing, firewall configuration, logging and the like. The detection module 226 monitors the ports 213 to determine if a wired connection to the router has been made. Once the detection module 226 detects that such a connection exists, the detection module 226 reads the network configuration data 224 of the router 201 and transmits this data to the computer system 200 over the data cable 220.

In this embodiment of the present invention, the computer system 200 comes pre-installed with a client application module 214, though other embodiments do not require a pre-installed client application (e.g., the client application module 214 may be resident at the router 201 and transmitted to computer system 200 upon detection of coupling between the router 201 and the computer system 200, as described below in conjunction with an embodiment of FIG. 4). The detection module 226 directly transmits the configuration data 224 to the client application module 214 through the data cable 220. In one embodiment, the client application module 214 listens on a “virtual port” of the computer system 200 for transmission control protocol/internet protocol (TCP/IP) data. In another embodiment, the client application module 214 listens on a “virtual port” of the computer system 200 for universal datagram protocol (UDP) packets. The client application module 214 receives the network configuration data 224 through an open virtual port, either as TCP/IP or UDP packet data.

The client application module 214 also has direct access to the network settings 216 of the system 200. To configure the connection between system 200 and router 201, under the control of firmware 218 and the client application module 214 the network settings 216 of system 200 are modified according to the network configuration data 224 of the router 201. A user may then disconnect cable 220 between the system 200 and the router 201 and use the WiFi™ port 222 as a means of wirelessly communicating requests to the router 201 to route to the internet 104. Thus, in accordance with this embodiment of the invention, the user did not perform any direct configuration actions except initially configuring the router 201, though often those initial settings are often preconfigured on the router 201 as well. When the user couples an Ethernet cable between ports 208 and 213, the configuration is automatically coordinated and performed by communication between the firmware 218 and the client application module 214

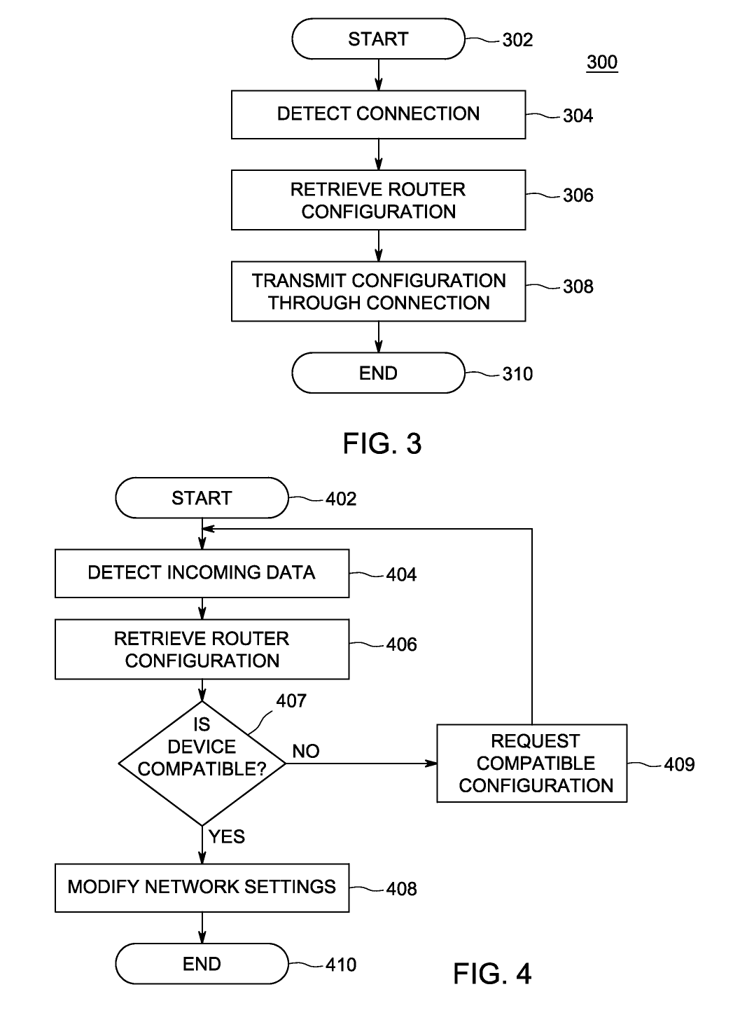

FIG. 3 depicts a flow diagram of a method 300 for detecting auto-configuring network devices in accordance with an embodiment of the present invention. The method 300 is an exemplary implementation of the detection module 226 of the router 201 as executed by the processor 203. The method begins at step 302 where, according to one exemplary embodiment of the present invention, a device is physically coupled using an Ethernet LAN cable or a USB cable to the ports 213 of router 201. Then method then proceeds to step 304.

At step 304, the detection module 226 detects the data connection coupled to the ports 213 of router 201. The detection module 226 detects the physical coupling of the device and one of the ports 213 of the router 201 by transmitting a small packet of data to the device and listening for a response. If such a low-level packet transmission is returned, the router 201 has detected a possibly couplable device. According to an alternate embodiment, at step 304 the detection module 226 detects a wireless device in range by transmitting a small packet through low-level wireless protocols and listening for a response from one or several devices. In one embodiment, if a device is detected over a LAN coupling the router performs Dynamic Host Configuration Protocol (DHCP) to set the IP address of the device. In another embodiment, if a device is detected over a USB coupling through a USB cable, the device views the router as a USB mass storage device and auto-runs the auto-configuration application stored on the router. Subsequently, DHCP is initiated to set the IP address of the device.

At step 306, the module 226 retrieves router network configuration data 224 from memory 205. Using the web interface 228, a user of the router 201 has previously configured network configuration data 224, which includes both settings for wired networking and wireless networking, of the router 201 to their desired settings. The settings are stored in the firmware 218 as user modifiable settings. The router 201 then waits for a special access response packet from the device which includes the devices media access control (MAC) address which indicates whether auto-registration is configured on the device.

At step 308, if a response packet from the device is received, the detection module 226 causes the firmware 205 to transmit the configuration data 224 through the connection established earlier through ports 213. In embodiments of the invention where a physical coupling is made between the device and the router 201, the network configuration data 224 is transmitted through the physical coupling, and the device itself remains physically coupled until the router 201 confirms that the device is successfully registered on the network. The network configuration data 224 is transmitted in the form of data packets which represent the desired network configuration in various “chunks” of data. The firmware 205 transmits the data as either TCP/IP or UDP packets. The method ends at step 310.

FIG. 4 depicts a flow diagram of a method 400 for auto-configuring a networked computer to a local area network in accordance with an embodiment of the present invention. The method 400 is an exemplary implementation of the client application module 214 of the computer system 200 as executed by processor 202. The method 400 is a general embodiment of the computer system 200 responding to the data detection module 226 transmitting network configuration data. The method begins at step 402 and proceeds to step 404.

At step 404, the client application module 214 installed in the memory 204 of computer system 200 detects incoming data into the computer system 200. In an exemplary embodiment, the client application module 214 is a Microsoft Windows® “service,” which is daemon software module running in the background continuously. In this embodiment, client application module 214 is listening on a particular virtual port where data is sent by the router 201. In an alternate embodiment, the client application module 214 is a software module running only when a user has enabled the module expressly through an interface in the operating system of the computer system 200. The client application module first retrieves DHCP information from the router 201 and after configuring a local IP, unicasts the special access request along with the MAC address of the device indicating whether auto-registration is configured and enabled, as discussed above with regards to step 306 of method 300.

At step 406, the client application module 214 retrieves the transmitted network configuration data 224. This network configuration data 224 may comprise the wireless service set identifier (SSID) of the wireless local network, the associated wireless security type, i.e., WiFi Protected Access (WPA), WiFi Protected Access—Pre-Shared Key (WPA-PSK), WPA2, and the like, the security key associated with the security type, the IP addresses of the DNS servers, the IP address of the router 201 and other wireless network configuration data. In one embodiment, the network configuration data 224 includes the client application module 214, discussed above with reference to FIG. 2 and below with reference to FIG. 4. In a setting where a device is not a Sony device, it is probable that the client application module 214 is not initially available on the device. Therefore, the router 201 firmware contains the client application module 214 executable file and transmits the client application module 214 as a binary executable file to the device, either through a wireless coupling or a wired physical coupling.

At step 407, it is determined whether the device on which client application module 214 is running as a service is compatible with the network configuration data received in step 406. In this context, compatibility indicates whether the device supports particular network configurations such as wireless security type, for example. If it is determined that the network configuration data 224 is compatible with the device, the method 400 proceeds to step 408.

Older devices may only conform to wireless 802.11a and 802.11b protocols, and cannot couple with, for example, a wireless 802.11g or 802.11n network. Other devices may only support WPA security options, therefore the network configuration received by the client application module 214 cannot be applied to the device. If the network configuration data is incompatible with the device, the method 400 moves to step 409 to request compatible network configuration data. In some instances, a router is capable of supporting several modes of operation simultaneously, i.e., the router transmits wireless signals for 802.11a, 802.11b, 802.11g and 802.11n simultaneously and supports multiple security types such as WPA, WPA2, WPA-PSK and the like and multiple SSIDs, allowing a multitude of devices with different compatibilities to couple with the router.

After step 409, the method 400 returns to step 404, where incoming data is detected once again. If at step 407 the data is determined to be compatible, at step 408 the client application module 214 modifies the network settings 216 of the computer 200, so that the computer 200 automatically has the security data (e.g., the security type, security key, and the like) for the wireless network of router 201 without any user interaction. The method ends at step 410.

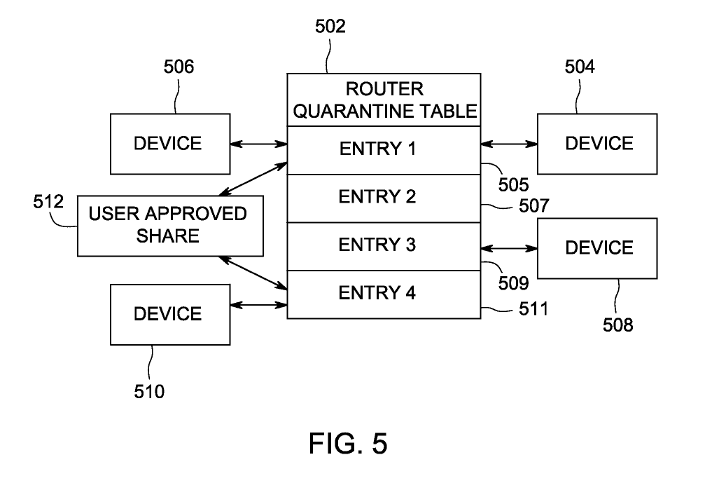

FIG. 5 depicts a block diagram of a mixed configuration local area network in accordance with embodiments of the present invention. According to one embodiment, the router has security customized to each client that auto-registers in the local area network. This is accomplished by storing a router quarantine table 502 in the quarantine module 230 of the router 201, which contains entries for each connecting client device and adds and removes entries dynamically. The router quarantine table 502 is stored in memory 218 of the router 201. The router quarantine table 502 cannot be directly accessed by any of connecting devices or users of the devices, and is only updated by the router 201 when a user initiates sharing a resource on their personal device. Only an administrator for the router 201 is able to login to the router 201 remotely and view the table. The quarantine table 502 contains information about each client device's shares and which other devices in the local area network can access those shares. Quarantine mode can be enabled or disabled as required by the administrator of the router 201.

By way of example, according to FIG. 5, there are four client devices 504, 506, 508 and 510 coupled to the router 201 (not shown), and each client device contains an a corresponding entry 505, 507, 509 and 510 in the quarantine table 502. In FIG. 5, Device 504 and Device 508 are “quarantined” from each other and from Device 506 and Device 510. However, Device 506 and 510 have access to a user approved private share 512. The quarantine table 502 filters by a Share ID which is the MAC address of the device being shared with. Device 506 and 510 can see each other's presence in the network, but cannot see other devices on the network. The quarantine function does not prevent access to the Internet, however.

Quarantining devices from each other in the local network area is a secure function of the router 201. Consequently, in one embodiment, the router 201 enforces a security convention such that in order a user of a client device to share data with other devices in the LAN, a number of protocols are configurable. In one embodiment, the devices that would like to share resources use a preconfigured user ID inside of the application used for sharing resources. In another embodiment, a client device uses the “Name” or MAC address of the device they intend to share with. In the case of a smart phone the Device name may be the phone number.

In another embodiment, a user of a first client device runs an application on the client device for transmitting an e-mail to the user of a device being shared with containing a link. A user of the target device opens the link and this creates a secure connection between two devices wishing to share resources. In yet another embodiment, port and protocol related filtering is used to permit sharing of data. This form of sharing is presented to the user as, for example, “Enable File Sharing” or “Enable Ping” and the like.

According to one embodiment, the router configuration table may contain the following entries:

ROUTER QUARANTINE TABLE
<MAC_ID>00-01-02-03-04-05</MAC_{—} ID> (Device 1 MAC
ID-reported by Device)
<SS_level>WPA2/AES</SS_level>(WWAN Protocol-reported by
Device)
<SS_ID>!JYT!5698qw34hafa8sdnz494019874</SS_ID>
(randomly generated by router)
<User_share>false</User_share>
<MAC_ID>00-06-07-08-09-A1</MAC_{—} ID> (Device 2 MAC
ID-reported by Device)
<SS_level>WPA2/AES</SS_level>(WWAN Protocol-reported by
Device)
<SS_ID>C@lming85Te@cup76adssa176235%ha</SS_ID>
(randomly generated by router)
<User_share>true</User_share>
<User_shareID>00-F1-A3-B5-C7-D9</User_shareID>
<MAC_ID>00-A2-B3-C4-D5-E6</MAC_{—} ID> (Device 3 MAC
ID-reported by Device)
<SS_level>WPA2/AES</SS_level>(WWAN Protocol-reported by
Device)
<SS_ID>cup76adssaM@tchbox32Coffeec@ke2</SS_ID>
(randomly generated by router)
<User_share>false</User_share>
<MAC_ID>00-F1-A3-B5-C7-D9</MAC_{—} ID> (Device 4 MAC
ID-reported by Device)
<SS_level>WPA2/AES</SS_level>(WWAN Protocol-reported by
Device)
<SS_ID>Ser3n1ty17ssaM@t*Snowf@ll16ubmi</SS_ID>
(randomly generated by router)
<User_share>true</User_share>
<User_shareID>00-06-07-08-09-A1</User_shareID>

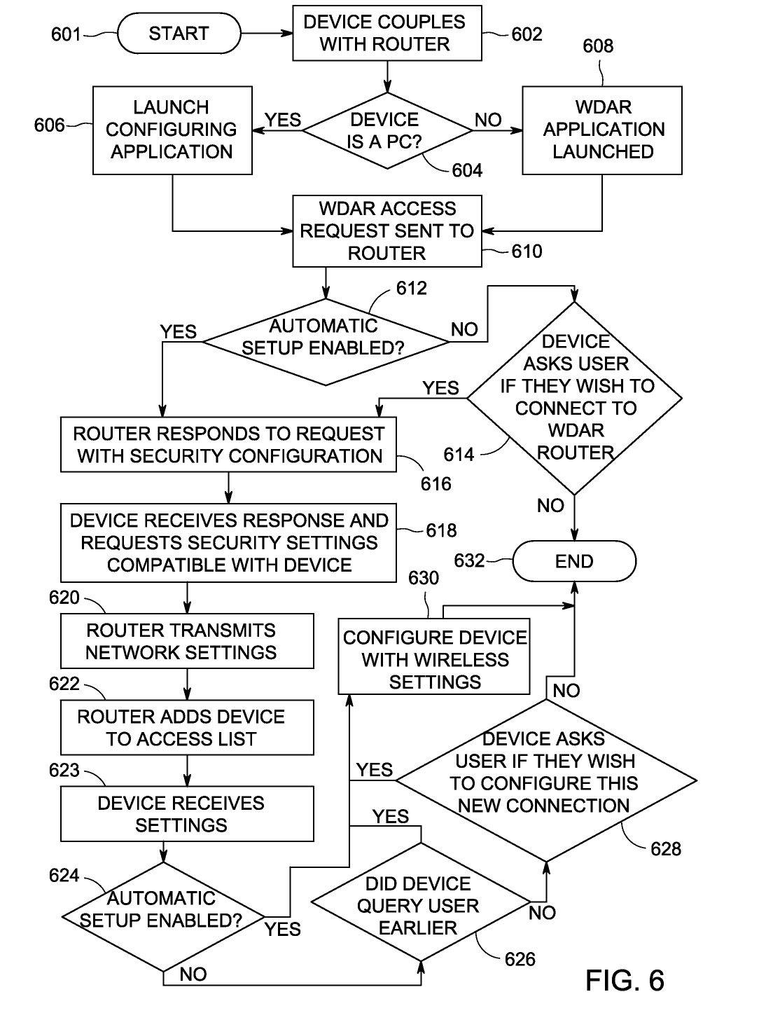

FIG. 6 depicts a flow diagram of a method 600 for auto-configuring local area network enabled devices to a network in accordance with embodiments of the present invention. The method begins at step 601 and proceeds to step 602. At step 602, a device, e.g., system 200, is connected via USB cable to a router, e.g., router 201. The device detects the router as a USB mass storage device class and the Operating System of the device configures a driver for the router as a mass storage device.

The method 600 proceeds to step 604 to determine if the device is a PC. If the device is a PC, at step 606, the router has auto-run enabled to automatically launch a configuration application for configuring network settings of the router on the device. If the device is not a PC, at step 608, in one embodiment, an application will be pre-installed on the device to detect a WDAR router. In another embodiment, a user of the device launches a particular WDAR application on their device.

At step 610, the launched application, or resident application on the device transmits a special WDAR ACCESS request to the router, which includes a request payload with the WiFi MAC address(es) of the device. If, at step 612, automatic setup is enabled on the device, the method 600 proceeds to step 616, where the router acknowledges the request and responds with a potential router security configuration, in the form of an XML list, bitmask, or other suitable configuration file format known to those of ordinary skill in the art. If automatic setup is not enabled at step 612, the method proceeds to step 614 where the device asks the user of the device if they wish to connect to the WDAR router. If the user disagrees, the method ends at step 632. If the user agrees, the method proceeds to step 616 as discussed above.

At step 618, the device parses the response from the router and requests the highest security level compatible with the device such as WPA2/AES or the like, as discussed above. The method proceeds to step 620, where the router receives the security setting request and responds with the configured WiFi SSID and encryption key for the security level requested. At step 622, the router adds the MAC address of the device to the router's access list and quarantine table. The device acknowledges the router's transmission of the SSID and key at step 623 and proceeds to determine if automatic setup is enabled at step 624.

If automatic setup is enabled at step 624, the device passes on network configuration information to the Operating System of the device to configure the wireless parameters. If automatic setup is not enabled, the method 600 determines at step 626 whether the device queried the user, earlier at step 614. If the user was already queried, the method again proceeds to step 630. If the user was not queried, at step 628 the user is queried. If the user agrees, the method again moves to step 630. If the user does not agree with the query request, the method ends at step 632. After step 630, the method also ends at step 632.

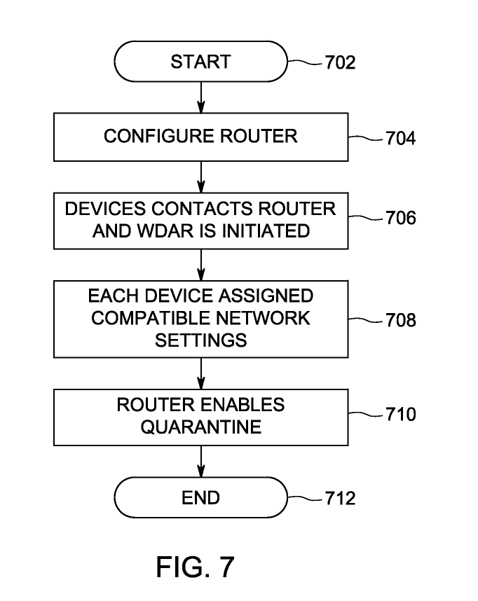

FIG. 7 depicts a flow diagram of a method 700 for auto-configuring non-local area network devices to a network in accordance with embodiments of the present invention. The method begins at step 702 and proceeds to step 704. At step 704, a router, e.g., router 201, is configured for an open, or public, network. The router WiFi SSD and other network settings as described above are set by an administrator of the router. At step 706, a user device contacts the router and wireless device auto-registration is initiated as discussed in method 600 and method 400.

At step 708, each connecting device is assigned corresponding compatible network settings such as WAN protocol and security level. The method then proceeds to step 710, where the router enables filtering security, such that devices are quarantined from each other. Thus, multiple devices may access a combination of shares on other devices and may be unpermitted to access other shares. The method ends at step 712.

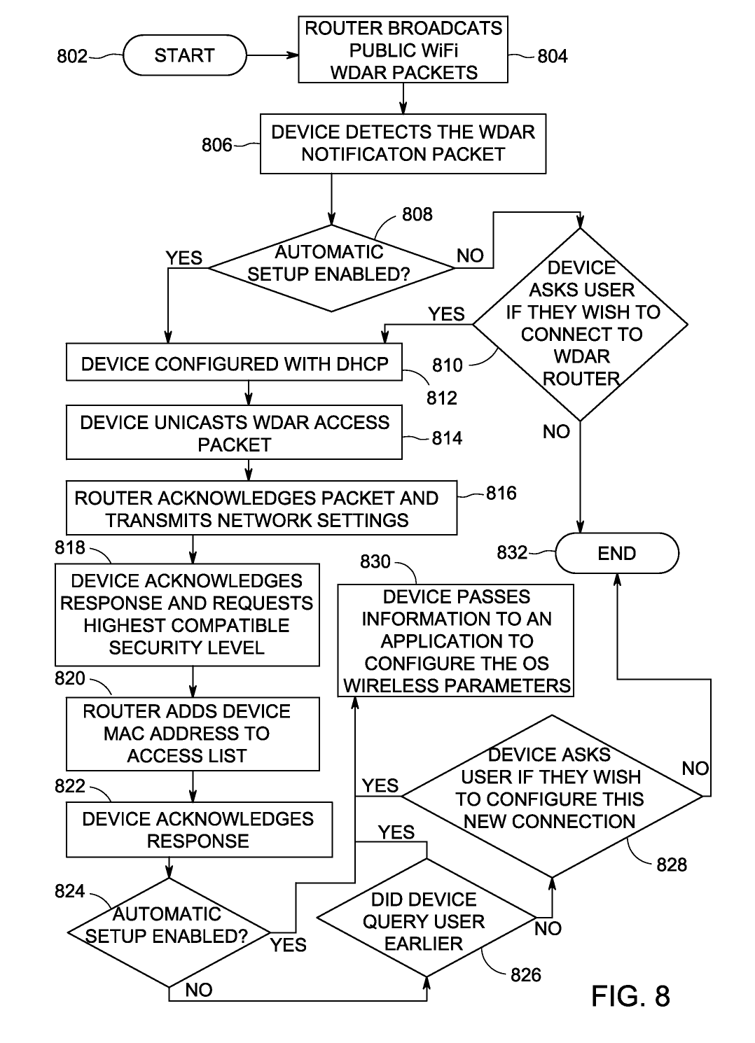

FIG. 8 depicts a flow diagram of a method 800 for auto-configuring multiple devices to a public network and enabling quarantining in accordance with embodiments of the present invention. The method begins at step 802 and proceeds to step 804. At step 804, a router, e.g., router 201, issues broadcast message on all WiFi channels promoting a Public WiFi WDAR specific NOTIFICATON packet including router SSID (similar to a beacon frame).

At step 806, a device, e.g., system 200, detects the WDAR NOTIFICATION packet. If automatic setup is enabled at step 808, the method proceeds to step 812, where the device connects to the router and performs DHCP configuration and the device receives an IP address accordingly. If automatic setup is not enabled, the device asks a user of the device if they wish to connect to the WDAR router at step 810. If the user agrees, the method moves to step 812. If the user does not agree, the method ends at step 832.

After step 812, the method proceeds to step 814, where the device unicasts a special WDAR ACCESS request packet to the router or gateway of the public network. At step 816, the router acknowledges the request and responds with potential router network settings, including security settings as discussed above, in the form of an XML list, bitmask, or other data formats known to those of ordinary skill in the art. At step 818, the device parses the response and the network settings and requests the highest security level compatible with the device. Once the router receives this request, at step 820, the router adds the MAC address of the device to the access list and quarantine table. The device acknowledges the router's response at step 822 and proceeds to determine if automatic setup is enabled at step 824.

If automatic setup is enabled at step 824, the device passes on network configuration information to the Operating System of the device to configure the wireless parameters. If automatic setup is not enabled, the method 800 determines at step 826 whether the device queried the user, earlier at step 814. If the user was already queried, the method again proceeds to step 830. If the user was not queried, at step 828 the user is queried. If the user agrees, the method again moves to step 830. If the user does not agree with the query request, the method ends at step 832. After step 830, the method also ends at step 832.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

While the foregoing is directed to embodiments of the present invention, other and further embodiments of the invention may be devised without departing from the basic scope thereof, and the scope thereof is determined by the claims that follow.

1. A method for auto-registering a device in a network comprising:
detecting a coupling of the device to a router;
retrieving network configuration data for the router; and
transmitting the network configuration through the coupling.

2. The method of claim 1 further comprising:
receiving the network configuration at the device; and
determining if the device is compatible with the network configuration.

3. The method of claim 2 further comprising:
applying the network configuration to the device if the device is compatible with the network configuration.

4. The method of claim 2 wherein the coupling is a physical coupling.

5. The method of claim 1 further comprising:
transmitting, to the device, an offer to connect to the network via the router; and
connecting to the device via the router if the offer is accepted by a user of the device.

6. The method of claim 1 wherein the coupling is a wireless coupling.

7. The method of claim 6 wherein transmitting the network configuration comprises:
transmitting at least a client application module to the device;
installing the client application module on the device; and
applying the network configuration to the device through the client application module.

8. The method of claim 1 further comprising:
detecting a decoupling of the device and the router; and
enabling wireless communication between the router and the device.

9. An apparatus for auto-registering a device in a network comprising:
a detection module for detecting a coupling of the device to a router, retrieving network configuration for the router and transmitting the network configuration data to the device through the coupling.

10. The apparatus of claim 9 further comprising a client application module for receiving the network configuration at the device and determining if the device is compatible with the network configuration data.

11. The apparatus of claim 10 further comprising the client application module applying the network configuration data to the device if the device is compatible with the network configuration.

12. The apparatus of claim 10 wherein the coupling is a physical coupling.

13. The apparatus of claim 9 further comprising wherein the detection module transmits to the device an offer to connect to the network via the router and the client application module connects to the network via the router if the offer is accepted by a user of the device.

14. The apparatus of claim 9 wherein the coupling is a wireless coupling.

15. The apparatus of claim 14 wherein the network configuration transmitted by the detection module comprises at least a client application module;
the device installs the client application module; and
the client application module applies the network configuration to the device.

16. The apparatus of claim 9 further comprising wherein the detection module detects a decoupling of the device and the router; and a firmware of the router enables wireless communication between the router and the device.

17. The apparatus of claim 8, further comprising a quarantine module with a table containing entries of a plurality of devices coupled to the router, where the entries indicate a level of access between shared resources of each of the plurality of devices.
